(19) United States
(12) Patent Application Publication
(10) Pub. No.: US 2006/0292437 A1
(43) Pub. Date: Dec. 28, 2006

(54) Sealed prismatic battery

(75) Inventors: Yoshimi Matsumoto, Ibaraki-shi (JP); Osamu Watanabe, Ibaraki-shi (JP); Yoshiki Somatomo, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/280,238

(22) Filed: Nov. 17, 2005

(30) Foreign Application Priority Data
Nov. 18, 2004 (JP) 2004-334022

(51) Int. Cl. H01M 2/12

(52) U.S. Cl. 429/56; 429/82

(57) ABSTRACT

A sealed prismatic battery includes a laterally elongated cap that closes the upper surface of the opening of a battery can 1 and a safety vent that is provided at the cap and opens when the battery internal pressure abnormally rises. The safety vent has a looped groove that is formed recessed and located nearer to the left end of the cap on the outer surface side of the cap. The looped groove is annularly formed of front, rear, left and right groove portions into a laterally elongated prismatic shape, and the thickness of the bottom wall of the end side groove portion is thicker than that of the bottom walls of the other groove portions. The center side groove portion of the looped groove is formed into a circular arc shape curved convex toward the center side of the cap.

### BACKGROUND OF THE INVENTION

The present invention relates to a sealed prismatic battery that has a safety vent which opens when a battery internal pressure abnormally rises.

In the sealed prismatic battery, a short circuit state occurs in the battery to generate a gas, and the battery internal pressure abnormally rises when an excessive electrical load is applied or an excessive thermal load is applied. Also, when the battery is excessively electrically charged, a gas is generated in the battery due to the decomposition of the electrolyte, and the battery internal pressure abnormally rises. When the battery becomes unable to endure the abnormal rise in the internal pressure, the battery ruptures and the contents scatter. Therefore, the battery has a safety vent that prevents the rupture of the battery in advance by releasing the battery internal pressure with open operation when the internal pressure becomes equal to or higher than a prescribed pressure.

There are prior art safety vents of JP H11-273640 A (FIGS. 1 and 2) and JP 2001-23596 A (FIG. 1). The vents have a looped groove provided at a cap that closes the upper surface of the opening of the battery can, and the bottom wall of the looped groove breaks to release the battery internal pressure when the battery internal pressure become equal to or greater than a prescribed value.

The looped groove of the safety vent in the above prior art is formed on the cap by press working, and therefore, it is difficult to uniform the thickness of the bottom wall of the looped groove of each battery during battery mass production. Therefore, a problem resides in that the opening pressure of the safety vent disadvantageously varies in each battery, lowering the reliability of the safety vent.

### SUMMARY OF THE INVENTION

An object of the present invention is to provide a sealed prismatic battery in which the opening pressure of the safety vent is stable even if the bottom wall of the looped groove of the safety vent varies in thickness in each battery during the course of mass production. It is to be note that the safety vent can be referred to as a break vent.

As shown in FIG. 4, a sealed prismatic battery according to the present invention includes a laterally elongated cap 3 that closes the upper surface of the opening of a battery can 1 and a safety vent 16 that is provided at the cap 3 and opens when the battery internal pressure abnormally rises.

In the sealed prismatic battery, as shown in FIG. 1, the safety vent 16 has a looped groove 19 that is formed recessed and located nearer to either end in the lateral direction of the cap 3 on the outer surface side of the cap 3. The looped groove 19 is annularly formed of front, rear, left and right groove portions 20, 21, 22 and 23, and the center side groove portion 23 located on the center side in the lateral direction of the cap 3 is formed into a circular arc shape that is curved convex toward the center side of the cap 3 as show in the plan view of FIG. 1. In the looped groove 19, the end side groove portion 22, which is located on the side opposite from the center side groove portion 23, is formed linearly extending in a depthwise direction which corresponds to an up-and-down direction in FIG. 1, and the thickness of the bottom wall of the end side groove portion 22 is dimensionally set thicker than that of the bottom walls of the other groove portions 20, 21 and 23.

More specifically, a recess 17 is formed recessed on the inner surface side of the cap 3 as shown in FIG. 2, and the looped groove 19 is arranged in a region where the recess 17 is formed as shown in FIG. 1.

Further, the front and rear groove portions 20 and 21 of the looped groove 19 are formed linearly extending parallel in the lateral direction.

When the battery internal pressure abnormally rises, the battery swells and deforms. Observing the behavior concretely based on an embodiment, the center portions of the front and rear walls of the battery can 1 swell in the depthwise direction as shown in FIG. 5. In accordance with this, the center portion of the cap 3 attempts to curve inwardly of the battery and deform into a bent shape such that the lateral end portions are lifted.

The end side groove portion 22 of the looped groove 19 deforms less easily by the increase in the thickness of the bottom wall thereof. Therefore, when a tensile force is applied in the depthwise direction to the cap 3 due to the swelling of the battery, a tongue portion 25 securely tears off the bottom wall of the front and rear groove portions 20 and 21 and the center side groove portion 23 of which the bottom walls have a small thickness by the tensile force and the battery internal pressure. By this operation, the safety vent 16 largely opens, swiftly releasing the battery internal pressure.

For example, when the thickness of the bottom wall of the end side groove portion 22 is made small, the cap 3 largely bends at the location of the end side groove portion 22 of the small thickness when the battery internal pressure abnormally rises, as a consequence of which the end portion side of the cap 3 plunges inwardly in the tongue portion 25 of the battery. Therefore, the tongue portion 25 becomes hard to deform outwardly of the battery by the battery internal pressure, and the safety vent 16 becomes hard to open.

That is, according to the safety vent 16 of the present invention, the end side groove portion 22 deforms less easily by the large thickness of the bottom wall of the end side groove portion 22 as described above, and the safety vent 16 operates effectively reliably when the battery internal pressure abnormally rises. Therefore, even if the thickness of the bottom wall of the looped groove 19 is varied by a manufacturing error, a stable opening pressure on the safety vent 16 can be obtained. Moreover, even if the battery internal pressure is not so high when the battery internal pressure abnormally rises, the safety vent 16 can reliably be broken. Since the end side groove portion 22 is formed linearly extending in the depthwise direction, an improved opening property of the safety vent 16 is obtained also from the viewpoint.

When the looped groove 19 is provided in the region where the recess 17 is formed, the bottom wall of a small thickness of the looped groove 19 can be easily reliably subjected to press working. Also, with this arrangement, the variation in the thickness of the bottom wall of the looped groove 19 can be reduced, and a more stable opening pressure of the safety vent 16 can be obtained.

By the front and rear groove portions 20 and 21 of the looped groove 19 being formed linearly extending parallel in the lateral direction, the bottom walls of the front and rear groove portions 20 and 21 can easily be torn off with the tongue portion 25.

### BRIEF DESCRIPTION OF THE DRAWINGS

The present invention will be further described with reference to the accompanying drawings wherein like reference numerals refer to like parts in the several views, and wherein:

FIG. 1 is a plan view of the cap of a sealed prismatic battery of Embodiment 1 and a partially enlarged view thereof;

FIG. 2 is a sectional view taken along a line A-A of FIG. 1;

FIG. 3 is a perspective view of a safety vent;

FIG. 4 is a longitudinal sectional front view of the battery;

FIG. 5 is a perspective view for explaining a state in which the battery swells;

FIG. 6 is a plan view of the cap of a battery of Comparative Example 1; and

FIG. 7 is a plan view of the cap of a battery of Comparative Example 3.

### DETAILED DESCRIPTION OF THE PREFERRED EMBODIMENTS

### Embodiment 1

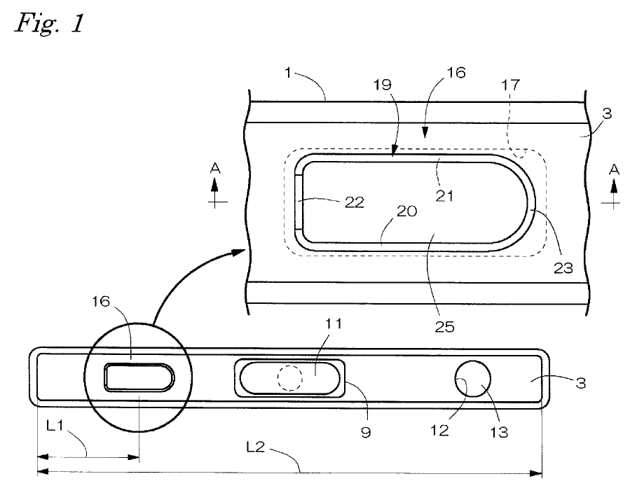

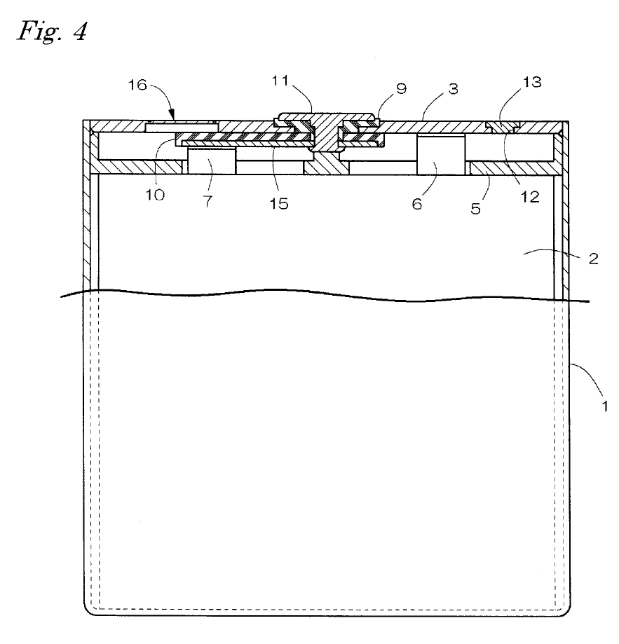

FIGS. 1 through 4 show a lithium ion secondary battery of Embodiment 1 as the sealed prismatic battery of the present invention. As shown in FIG. 4, the battery has a closed bottom prismatic tube-shaped battery can 1 that has a laterally elongated opening on its upper surface, an electrode body 2 and a nonaqueous electrolyte housing in the battery can 1, a laterally elongated cap 3 that closes the upper surface of the opening of the battery can 1, an insulator 5 made of a plastic material placed inside the cap 3 and so on. The battery can 1 was formed into a vertically elongated thin type by processing a plate material made of aluminum or its alloy by deep drawing with a width of 34 mm, a height of 50 mm and a thickness of 3.8 mm.

The electrode body 2 is formed by winding sheet-shaped positive and negative electrodes with interposition of a separator made of a microporous polyethylene film into a roll shape. A thin plate-shaped positive electrode current collection lead 6 made of aluminum or an aluminum alloy is upwardly led from the positive electrode. A thin plate-shaped negative electrode current collection lead 7 made of nickel, copper or a complex of these substances is upwardly led from the negative electrode.

The cap 3 is obtained by press forming a plate material of an aluminum alloy or the like and seam welding the outer peripheral edge of the cap 3 to the peripheral edge of the opening of the battery can 1 by laser. A negative electrode terminal 11 is penetratively provided at the center of the cap 3 via an insulating packing 9 located on the upper side and an insulating plate 10 located on the lower side. A circular liquid inlet 12 for injecting an electrolyte into the battery can 1 is vertically penetratively formed nearer to the right end in the lateral direction of the cap 3. The liquid inlet 12 is sealed by being closed by a plug 13 after the injection of the electrolyte.

A lead 15 constructed of a laterally elongated thin plate is connected to the lower end of the negative electrode terminal 11 on the inner surface of the cap 3. The lead 15 extends toward the opposite side of the liquid inlet 12 and is insulated from the cap 3 by the insulating plate 10 located on the lower side. The negative electrode current collection lead 7 is laser welded to the lower surface of the lead 15. The positive electrode current collection lead 6 is laser welded to a space located between the insulating plate 10 and the liquid inlet 12 on the back surface of the cap 3. With this arrangement, the positive electrode current collection lead 6 is electrically connected to the cap 3 and the battery can 1, and the cap 3 and the battery can 1 are electrically charged with the positive potential.

In assembling the battery, the negative electrode terminal 11, the upper and lower insulating packings 9, 10 and the lead 15 are attached to the cap 3, and after the electrode body 2 is housed in the battery can 1, the negative electrode current collection lead 9 and the positive electrode current collection lead 6 are welded to the lead 15 and the cap 3, respectively, in the manner as described above. Next, by seal welding the cap 3 to the periphery of the opening of the battery can 1, thereafter injecting the electrolyte into the liquid inlet 12 and sealing the liquid inlet 12, the battery of the present invention is completed.

The safety vent 16 that opens when the battery internal pressure abnormally rises is formed nearer to one end (nearer to the left end in the figure) in the lateral direction of the cap 3. As shown in FIGS. 1 through 3, the safety vent 16 is constructed of the recess 17 that is formed recessed on the inner surface side of the cap 3 and a laterally elongated rectangular looped groove 19 formed recessed on the outer surface of the cap 3 within the region where the recess 17 is formed. The recess 17 has a laterally elongated rectangular contour in the plan view.

The looped groove 19 is annularly formed of the front and rear groove portions 20 and 21 and the left and right groove portions 22 and 23 and arranged along the peripheral side surfaces of the recess 17. The right center side groove portion 23 located on the center side in the lateral direction of the cap 3 is formed into a circular arc shape curved convex toward the center side of the cap 3 in the plan view. The left end side groove portion 22 is formed linearly extending in the depthwise direction.

The front and rear groove portions 20 and 21 are formed linearly extending parallel in the lateral direction. A portion surrounded by the looped groove 19 serves as a laterally elongated tongue portion 25. The groove width dimensions of the groove portions 20, 21, 22 and 23 are set equal to one another. The recess 17 and the looped groove 19 are formed by press working.

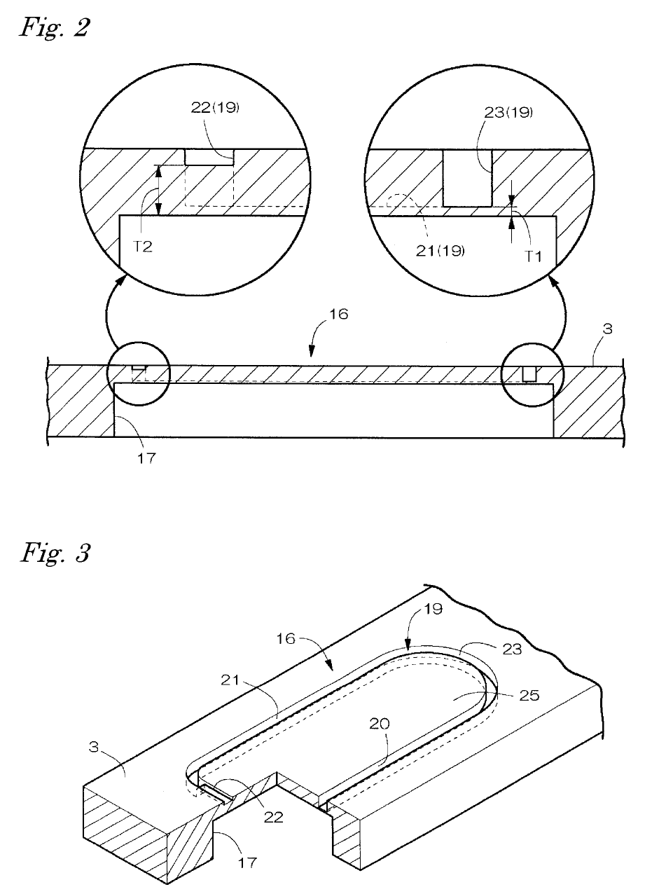

In the looped groove 19 shown in FIG. 2, the vertical depth of the end side groove portion 22 is shallower than the vertical depth of each of the other groove portions 20, 21 and 23. With this arrangement, the thickness of the bottom wall of the end side groove portion 22 is made thicker than that of each of the bottom walls of the other groove portions 20, 21 and 23. That is, the thickness dimension T1 of each of the bottom walls of the front groove portion 20, the rear groove portion 21 and the center side groove portion 23 was set to 0.028 mm, and the thickness dimension T2 of the bottom wall of the end side groove portion 22 was set to 0.15 mm. The cap 3 was made to have a lateral width dimension of 33 mm, a depthwise width dimension of 3 mm and a vertical thickness dimension of 0.8 mm. Both depthwise end portions of the end side groove portion 22 have a reduced thickness so that the bottom wall of the end side groove portion 22 easily bends after the opening.

The safety vent 16 is placed in a portion where the cap 3 bends when the swelling deformation of the battery occurs as a consequence of an abnormal rise in the battery internal pressure. That is, the length dimension L1 from the lateral center of the safety vent 16 to the left end of the cap 3 was set to approximately 6.8 mm. The safety vent 16 was made to have a width of 5 mm and a depthwise width dimension of 2 mm.

A ratio (L1/L2) between the length dimension L1 from the lateral center of the safety vent 16 to the left end of the cap 3 and the width L2 of the cap 3 should preferably fall within a range of 0.1 to 0.25 and set to approximately 0.2 in Embodiment 1. If the ratio is smaller than 0.1, the safety vent 16 is located extremely nearer to the left end of the cap 3, and this makes it difficult for the safety vent 16 to open as a consequence of the compression of the safety vent 16 in the lateral direction when the battery internal pressure rises. If the ratio is greater than 0.25, the lead 15 overlaps the lower surface of the safety vent 16 because the safety vent 16 is located extremely nearer to the center side of the battery, and it is concerned that the blow of gas from inside the battery is obstructed, possibly causing the rupture of the battery.

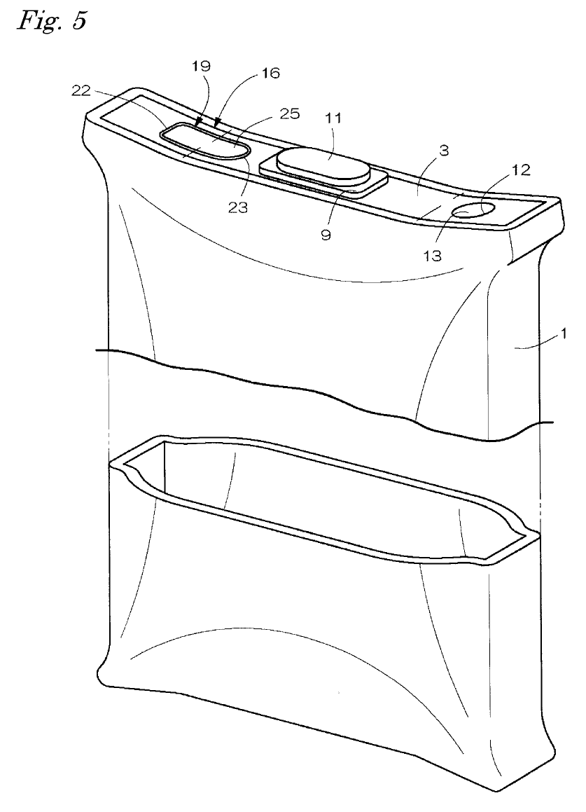

When the swelling deformation of the battery is caused by an abnormal rise in the battery internal pressure, the center portions of the front and rear walls of the battery can 1 swell as shown in FIG. 5, with which the center portions of the cap 3 bend inwardly of the battery, and the cap 3 attempts to deform into a bent shape such that the lateral end portions are lifted. The bottom wall of the end side groove portion 22 of the looped groove 19 deforms less easily by the increase in the thickness dimension T2 thereof, and the bottom walls of the front and rear groove portions 20 and 21 and the center side groove portion 23 are torn off by a tension force exerted in the depthwise direction of the cap 3 in accordance with the swelling of the battery and the battery internal pressure.

Then, the gas in the battery blows from the rips of the bottom walls of the groove portions 20, 21 and 23, and the tongue portion 25 is lifted upward by being pushed by the blow of gas, completely tearing off the bottom walls of the groove portions 20, 21 and 23. As a result, the safety vent 16 largely opens to swiftly release the battery internal pressure. After the opening, the bottom wall of the end side groove portion 22 remains untorn, and the tongue portion 25 is connected to the cap 3.

### Embodiment 2

In Embodiment 2, the thickness dimension T1 of each of the bottom walls of the groove portions 20, 21 and 23 other than the end side groove portion 22 was dimensionally set to 0.031 mm at the safety vent 16. Since other points are the same as those of Embodiment 1, no description is provided therefor.

### Embodiment 3

In Embodiment 3, the thickness of the battery was largely set to 4.0 mm, and the depthwise width dimension of the safety vent 16 was largely set to 2.5 mm in accordance with the enlargement of the thickness of the battery. The thickness dimension T1 of each of the bottom walls of the groove portions 20, 21 and 23 other than the end side groove portion 22 was dimensionally set to 0.035 mm. The other points were the same as those of Embodiment 1.

### Embodiment 4

In Embodiment 4, the thickness of the battery was largely set to 4.0 mm as in Embodiment 3, and the depthwise width dimension of the safety vent 16 was dimensionally set to 2.5 mm. The thickness dimension T1 of each of the bottom walls of the groove portions 20, 21 and 23 other than the end side groove portion 22 was dimensionally set to 0.038 mm. The other points were the same as those of Embodiment 1.

### Embodiment 5

In Embodiment 5, the width of the battery was set to 30 mm, the height was set to 48 mm, and the thickness was set to 4.0 mm. In accordance with these dimensions, the depthwise width dimension of the safety vent 16 was dimensionally largely set to 2.5 mm. The thickness dimension T1 of each of the bottom walls of the groove portions 20, 21 and 23 other than the end side groove portion 22 was dimensionally set to 0.035 mm. The other points were the same as those of Embodiment 1.

### Embodiment 6

In Embodiment 6, the width of the battery was set to 30 mm, the height was set to 48 mm, the thickness was set to 4.0 mm, and the depthwise width dimension of the safety vent 16 was dimensionally set to 2.5 mm as in Embodiment 5. The thickness dimension T1 of each of the bottom walls of the groove portions 20, 21 and 23 other than the end side groove portion 22 was dimensionally set to 0.038 mm. The other points were the same as those of Embodiment 1.

### Comparative Example 1

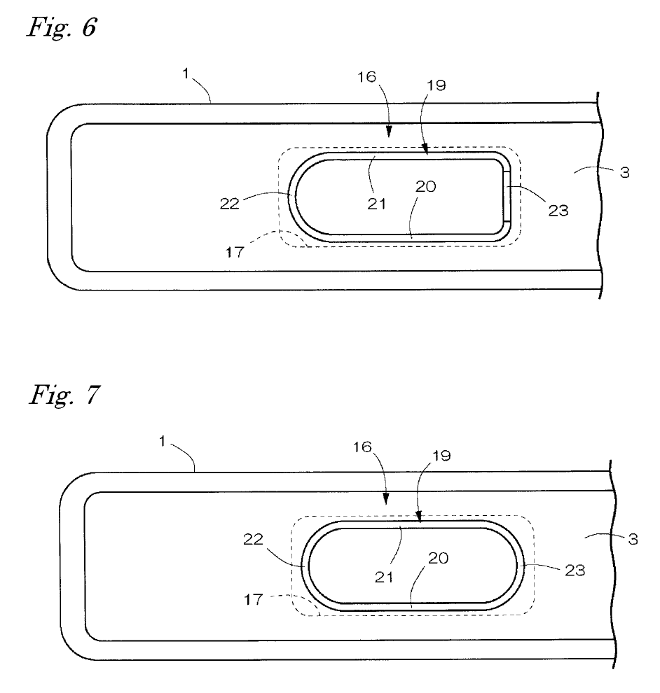

In Comparative Example 1, the direction of the safety vent 16 was formed laterally reversed with respect to that of Embodiment 1, as shown in FIG. 6. That is, in Comparative Example 1, the left end side groove portion 22 was formed into a circular arc shape, the right center side groove portion 23 was formed linearly in the depthwise direction, and the thickness dimension of the bottom wall of the center side groove portion 23 was dimensionally set to 0.15 mm. The thickness dimensions of the bottom walls of the groove portions 20, 21 and 22 other than the center side groove portion 23 were each dimensionally set to 0.028 mm. The other points were the same as those of Embodiment 1.

### Comparative Example 2

In Comparative Example 2, the thickness dimensions of the bottom walls of the groove portions 20, 21 and 22 other than the center side groove portion 23 were each dimensionally set to 0.031 mm. The other points were the same as those of Comparative Example 1.

### Comparative Example 3

In Comparative Example 3, as shown in FIG. 7, the left and right groove portions 22 and 23 of the safety vent 16 were formed into a circular arc shape, and the thickness dimensions of the bottom walls of the front, rear, left and right groove portions 20, 21, 22 and 23 were all dimensionally set to 0.028 mm. The other points were the same as those of Embodiment 1.

### Comparative Example 4

In Comparative Example 4, the direction of the safety vent 16 was laterally reversed as in Comparative Example 1. On the above basis, the thickness of the battery was set to 4.0 mm, and the depthwise width dimension of the safety vent 16 was set to 2.5 mm as in Embodiment 3. The thickness dimensions of the bottom walls of the groove portions 20, 21 and 22 other than the center side groove portion 23 were each dimensionally set to 0.035 mm. The other points were the same as those of Embodiment 1.

### Comparative Example 5

In Comparative Example 5, the thickness dimensions of the bottom walls of the groove portions 20, 21 and 22 other than the center side groove portion 23 were each dimensionally set to 0.038 mm. The other points were the same as those of Comparative Example 4.

### Comparative Example 6

In Comparative Example 6, the left and right groove portions 22 and 23 were formed into a circular arc shape as in Comparative Example 3. The thickness of the battery was dimensionally set to 4.0 mm as in Comparative Example 4. Further, the thickness dimensions of the bottom walls of the front, rear, left and right groove portions 20, 21, 22 and 23 were all dimensionally set to 0.035 mm. The other points were the same as those of Embodiment 1.

### Comparative Example 7

In Comparative Example 7, the width of the battery was set to 30 mm, the height was set to 48 mm, the thickness was set to 4.0 mm, and the depthwise width dimension of the safety vent 16 was set to 2.5 mm as in Embodiment 5. On the above basis, the thickness dimensions of the bottom walls of the groove portions 20, 21 and 22 other than the center side groove portion 23 were each dimensionally set to 0.035 mm. The other points were the same as those of Embodiment 1.

### Comparative Example 8

In Comparative Example 8, the thickness dimensions of the bottom walls of the groove portions 20, 21 and 22 other than the center side groove portion 23 of the safety vent 16 were each dimensionally set to 0.038 mm. The other points were the same as those of Comparative Example 7.

### Comparative Example 9

In Comparative Example 9, the left and right groove portions 22 and 23 were formed into a circular arc shape as in Comparative Example 3, and the thickness dimensions of the bottom walls of the front, rear, left and right groove portions 20, 21, 22 and 23 were all dimensionally set to 0.035 mm. Moreover, as in Embodiment 5, the width of the battery was set to 30 mm, the height was set to 48 mm, the thickness was set to 4.0 mm, and the depthwise width dimension of the safety vent 16 was dimensionally set to 2.5 mm. The other points were the same as those of Embodiment 1.

That is, Embodiments 1 and 2, Embodiments 3 and 4 and Embodiments 5 and 6 have mutually different battery dimensions. In accordance with these dimensions, Comparative Examples 1 through 3 have the same battery dimensions as those of Embodiments 1 and 2, Comparative Examples 4 through 6 have the same battery dimensions as those of Embodiments 3 and 4, and Comparative Examples 7 through 9 have the same battery dimensions as those of Embodiments 5 and 6.

The reason why the thickness dimension T1 of each of the bottom walls of the groove portions 20, 21 and 23 other than end side groove portion 22 was varied by about 0.003 mm among Embodiments 1 and 2, Embodiments 3 and 4 and Embodiments 5 and 6, was in consideration of the fact that the thickness dimension of the bottom wall of the looped groove 19 is varied by about 0.003 mm during the processing of the safety vent 16.

Fifty batteries per each Embodiment of Embodiments 1 through 6 of the present invention and fifty batteries per each Comparative Example of Comparative Examples 1 through 9 were prepared, the opening pressure of the safety vent 16 was measured, and the opening property was confirmed. In this case, a hole was formed through the bottom wall of the battery can 1 instead of housing the electrode body 2 and the electrolyte in each battery can 1. The opening pressure of the safety vent 16 was measured and the opening property was confirmed by gradually increasing the battery internal pressure (hydraulic pressure) with water injected from the hole into the battery.

That is, according to the measurement of the opening pressure, the hydraulic pressure when the safety vent 16 opened or when a crack occurred and water begun to leak was measured as the opening pressure. During the confirmation of the opening property, the number of cases that were visually perceived as the occurrence of almost complete break of the groove portions other than the groove portion of the increased bottom wall thickness was counted. Table 1 shows the results.

TABLE 1

| | Opening pressure | Opening property |
|---|---|---|
| | (MPa) | (number) |
| Embodiment 1 | 1.64 | 48 |
| Embodiment 2 | 1.75 | 50 |
| Embodiment 3 | 1.50 | 50 |
| Embodiment 4 | 1.62 | 50 |
| Embodiment 5 | 1.50 | 50 |
| Embodiment 6 | 1.63 | 50 |
| Comparative Example 1 | 1.70 | 23 |
| Comparative Example 2 | 1.98 | 25 |
| Comparative Example 3 | 1.70 | 18 |
| Comparative Example 4 | 1.57 | 27 |
| Comparative Example 5 | 1.88 | 30 |
| Comparative Example 6 | 1.58 | 22 |
| Comparative Example 7 | 1.59 | 26 |
| Comparative Example 8 | 1.90 | 31 |
| Comparative Example 9 | 1.60 | 24 |

With regard to the measurement of the opening pressure, as shown in Table 1, in contrast to the fact that the opening pressures of Embodiments 1 and 2 fluctuate by a small amount of 0.11 MPa from 1.64 to 1.75 MPa, the opening pressures of Comparative Examples 1 and 2 fluctuate by a considerable amount of 0.28 MPa from 1.70 to 1.98 MPa. With regard to the confirmation of the opening property, in contrast to the fact that complete opening occurred in almost all the batteries as seen from the counts of forty-eight and fifty in terms of the number of the batteries where the opening occurred in Embodiments 1 and 2, incomplete opening occurred in the majority of the batteries as seen from the counts of twenty-three and twenty-five in terms of the number of the batteries where the opening occurred in Comparative Examples 1 and 2.

In Comparative Example 3, the opening pressure is 1.70 MPa, which is equal to that of Comparative Example 1. In Comparative Example 3, the number of batteries where the opening occurred was eighteen, meaning that incomplete opening occurred in many batteries. This is presumably ascribed to the fact that the break of the bottom wall of the looped groove 19 depends on only the battery internal pressure in Comparative Example 3, and it can be understood that the break of the bottom wall of the looped groove 19 depends on only the battery internal pressure also in Comparative Example 1 because the opening pressure of Comparative Example 1 is equal to that of Comparative Example 3.

In contrast to the fact that the opening pressures fluctuate by a small amount of 0.12 MPa from 1.50 to 1.62 MPa in Embodiments 3 and 4, the opening pressures fluctuate by a considerable amount of 0.31 MPa from 1.57 to 1.88 MPa in Comparative Examples 4 and 5. Likewise, in contrast to the fact that the opening pressures fluctuate by a small amount of only 0.13 MPa from 1.50 to 1.63 MPa in Embodiments 5 and 6, the opening pressures fluctuate by a considerable amount of 0.31 MPa from 1.59 to 1.90 MPa in Comparative Examples 7 and 8.

With regard to the confirmation of the opening property, in contrast to the fact that the number of the batteries where the opening occurred was fifty, meaning that complete opening occurred in all the batteries in Embodiments 3 to 6, the number of the batteries where the opening occurred was twenty-seven in Comparative Example 4, the number of the batteries where the opening occurred was thirty in Comparative Example 5, the number of the batteries where the opening occurred was twenty-six in Comparative Example 7, and the number of the batteries where the opening occurred was thirty-one in Comparative Example 8, meaning that incomplete opening occurred in many batteries.

In Comparative Example 6, the opening pressure was 1.58 MPa, which is approximately equal to that of Comparative Example 4, and the number of batteries where the opening occurred was twenty-two, meaning that incomplete opening occurred in many batteries. In Comparative Example 9, the opening pressure was 1.60 MPa, which is approximately equal to that of Comparative Example 7, and the number of the batteries where the opening occurred was twenty-four, meaning that incomplete opening occurred in many batteries.

As described above, it can be understood that the safety vents 16 of Embodiments 1 through 6 have small fluctuations in the opening pressure and an improved opening property even if the thickness dimension of the bottom wall of the looped groove 19 is varied by a manufacturing error and therefore stable operation of the safety vent 16 can be obtained even if batteries are mass produced. Furthermore, the safety vents 16 of Embodiments 1 through 6 have opening pressures lower than those of Comparative Examples 1 through 9, and more reliable opening can be achieved by this much. Moreover, it can be understood that these effects can be obtained even if the battery dimensions are changed.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A sealed prismatic battery comprising a laterally elongated cap that closes an upper surface of an opening of a battery can and a safety vent that is provided at the cap and opens when a battery internal pressure abnormally rises, wherein
the safety vent has a looped groove that is formed recessed and located to either end in the lateral direction of the cap on an outer surface side of the cap,
the looped groove is annularly formed of front, rear, left and right groove portions, among which a center side groove portion located on a center side in the lateral direction of the cap is formed into a circular arc shape curved convex toward the center side of the cap in a plan view,
an end side groove portion of the looped groove is located on a side opposite from the center side groove portion and formed linearly extending in a depthwise direction, and a thickness of a bottom wall of the end side groove portion is dimensionally set thicker than that of bottom walls of the other groove portions.

2. The sealed prismatic battery as claimed in claim 1, wherein
the safety vent includes a recess that is formed recessed on an inner surface side of the cap, and
the looped groove is placed in a region where the recess is formed.

3. The sealed prismatic battery as claimed in claim 2, wherein
the front and rear groove portions of the looped groove are formed linearly extending parallel in the lateral direction.
